(19) United States
(12) Patent Application Publication
(10) Pub. No.: US 2021/0347126 A1
(43) Pub. Date: Nov. 11, 2021

(54) IMAGED TRANSMISSION PERCENTAGES FOR 3D PRINTERS

(71) Applicant: Hewlett-Packard Development Company, L.P., Spring, TX (US)

(72) Inventors: Ingeborg Tastl, Palo Alto, CA (US); Melanie M. Gottwals, Palo Alto, CA (US); Nathan Moroney, Palo Alto, CA (US); Jian Fan, Palo Alto, CA (US)

(73) Assignee: Hewlett-Packard Development Company, L.P., Spring, TX (US)

(21) Appl. No.: 17/284,102

(22) PCT Filed: Dec. 7, 2018
(86) PCT No.: PCT/US2018/064397

§ 371 Date: Apr. 9, 2021

(51) Int. Cl. B29C 64/393; G06T 7/00; G06T 7/90; B33Y 10/00; B33Y 50/02

(52) U.S. Cl. CPC B29C 64/393; G06T 7/0004; G06T 7/90; G06T 2207/30144; B33Y 50/02; G06T 2207/10024; G06T 2207/10152; B33Y 10/00

(57) ABSTRACT

In example implementations, an apparatus is provided. The apparatus includes a light table, a camera, and a processor. The light table is to hold an object. The camera is to capture images. The light table is positioned within a field of view of the camera. The processor is communicatively coupled to the camera to receive the images. The processor is to analyze the images to calculate an imaged transmission percentage at a plurality of different locations of the object based on a correlation function of the camera used to determine an amount of print agents to be dispense by a three dimensional printer to print the object.

### BACKGROUND

Three dimensional (3D) printers can be used to print 3D objects. The 3D objects can either be prototypes for final products or fully functional objects or parts of objects that are being used in final products. The application areas range from the car and airplane industry to medical devices used for surgery, to prosthetics, to fixtures, and the like. 3D printers can print 3D objects in a variety of different ways. For example, some 3D printers can print 3D objects using an additive process and other 3D printers can print 3D objects using a subtractive process. The 3D printers can print the 3D objects based on instructions obtained from a 3D model that is generated on a separate computer system. The instructions may control the dispensing of print material and agents from printheads on a movable platform that build the 3D object layer by layer.

### BRIEF DESCRIPTION OF THE DRAWINGS

FIG. 1 is a block diagram of an example system to calculate a correlation function of a camera of the present disclosure;

FIG. 2 is a block diagram of an example apparatus for obtaining color data to control a 3D printer of the present disclosure;

FIG. 3 is a flow chart of an example method for calculating a correlation function of the present disclosure;

FIG. 4 is a flow chart of an example method for controlling a 3D printer to print an object using light transmission data that is calculated based on the correlation function of the present disclosure; and

FIG. 5 is a block diagram of an example non-transitory computer readable storage medium storing instructions executed by a processor to calculate a light transmission percentage of an object to control a 3D printer to print the object.

### DETAILED DESCRIPTION

Examples described herein provide an apparatus and method to measure color and/or transmission data for 3D printers. As discussed above, 3D printers can be used to print different 3D objects that are either prototypes of final parts or fully functional final parts themselves. If hundreds or thousands of copies of the same parts are printed it is desirable that the color and/or the degree of light transmission of each object is consistent from one object to the next (e.g. red interlocking toy brick parts should be consistent). Appearance attributes of the 3D printed objects may be measured, compared with some goal values, and the corresponding objects are either accepted or rejected for delivery. This is part of a process control for both 2D and 3D printing. In the case of 3D printing, the 3D printing process control can also include other attributes like size and mechanical attributes for example.

The color and the opacity of a 3D printed object may be determined by the printing material, the amount of agents that are being used, and the printing parameters of the printing process itself. A characterization process, in which printing agents are systematically changed, and the corresponding appearance attributes of 3D printed samples of a specific size and thickness are measured, may be performed to establish the amount of agents used to achieve a specific color and/or opacity. Thus, this set-up process may use the accurate and efficient measurement of a large set of 3D printed samples.

In some implementations, expensive color measurement devices can be used to measure the transmission percentage (e.g., the percentage of light that is transmitted through a material). These systems perform spot color measurements. Thus, the system is placed on a programmable x-y station and the system is moved from spot to spot to perform the spot color measurement and then calculate the percentage of transmission. This can be a time consuming and inefficient process.

Examples herein provide an apparatus and method that allow any type of vision camera to be used. The camera can be calibrated with a standard transmission chart on a light table to calculate a correlation function for the camera. The transmission percentage of an object may then be calculated by capturing an image of the object on the light table with the same camera and an image of the light table without the object. The red, green, blue (RGB) values of each pixel of the image can be converted into a luminance value using the correlation function. Then, the transmission percentage at a particular location of the object may be calculated. For example, the transmission percentage at the location may be based on a comparison of the luminance value of the object at that location versus the luminance value of the light table without the object at that location.

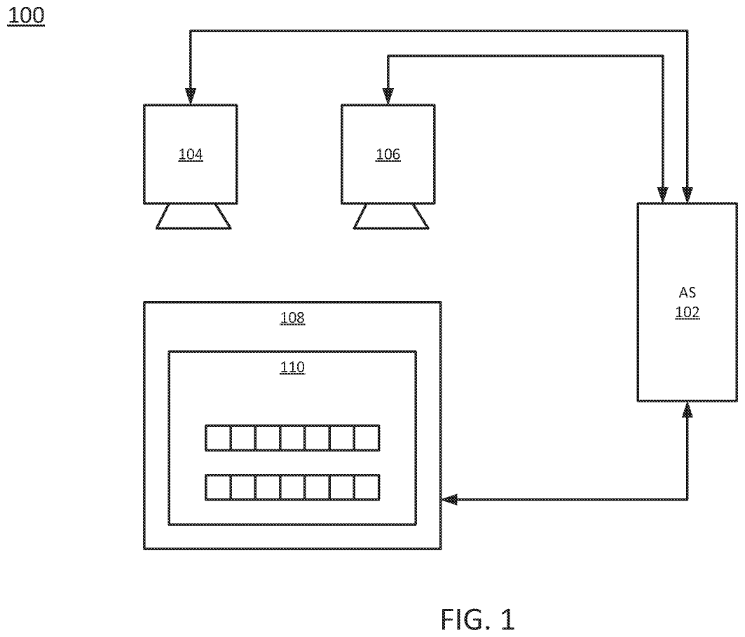

FIG. 1 illustrates an example of a system 100 to calculate a correlation function of a camera of the present disclosure. In one example, the system 100 may include an application server (AS) 102, a camera 104, a tele-spectrophotometer 106, a light table 108, and a standardized transmission chart 110. In one example, the AS 102 may include a processor and a memory. The memory may store data received from the camera 104 and the tele-spectrophotometer 106, data calculated by the processor, instructions to be executed by the processor to perform functions described herein, and the like.

In one example, the AS 102 may be communicatively coupled to the camera 104, the tele-spectrophotometer 106, and the light table 108. The AS 102 may control operation of the camera 104, the tele-spectrophotometer 106, and the light table 108. For example, the AS 102 may instruct the camera 104 to capture images of the standardized transmission chart 110, control settings of the camera 104, and the like. The AS 102 may instruct the tele-spectrophotometer 106 to measure luminance values of different locations of the standardized transmission chart 110. The AS 102 may also turn the light table 108 on and off, control a brightness level of the light table 108, and the like.

In one example, the camera 104 may be any type of image capturing device. The camera 104 may be a red, green, blue (RGB) camera, a monochrome camera, a hyperspectral camera, and the like. The camera 104 may be any available camera such as a point and shoot camera, a camera on a mobile device, a camera on a tablet device, a camera on a laptop, a digital single lens reflex (DSLR) camera, a mirrorless camera, and the like. In other words, the camera 104 may be a widely available camera rather than a specialized expensive color measurement device.

In one example, the light table 108 may be positioned to be within a field of view of the camera 104. For example, the entire light table 108 may be within the field of view of the camera 104. In one example, the camera 104 may be positioned above the light table 108. In one example, the camera 104 may be positioned above the light table 108 at approximately 90 degrees (e.g., a light ray emitted from the light table 108 may be 90 degrees relative to a surface of a lens of the camera 104).

The camera 104 may capture an image of the standardized transmission chart 110. The standardized transmission chart 110 may include a plurality of patches. For example, one row may have patches in increments from 10% light transmission to 100% light transmission. A second row may have patches in increments from 1% light transmission to 10% light transmission.

The image captured by the camera 104 may be analyzed to obtain RGB values for each pixel within an area of one of the light transmission windows of the standardized transmission chart 110. The camera 104 may capture the image at an appropriate camera exposure setting such that neither the dark areas nor the light areas are clipped. Other camera settings, such as gamma values, can be noted. The camera RGB values may then be converted into luminance values.

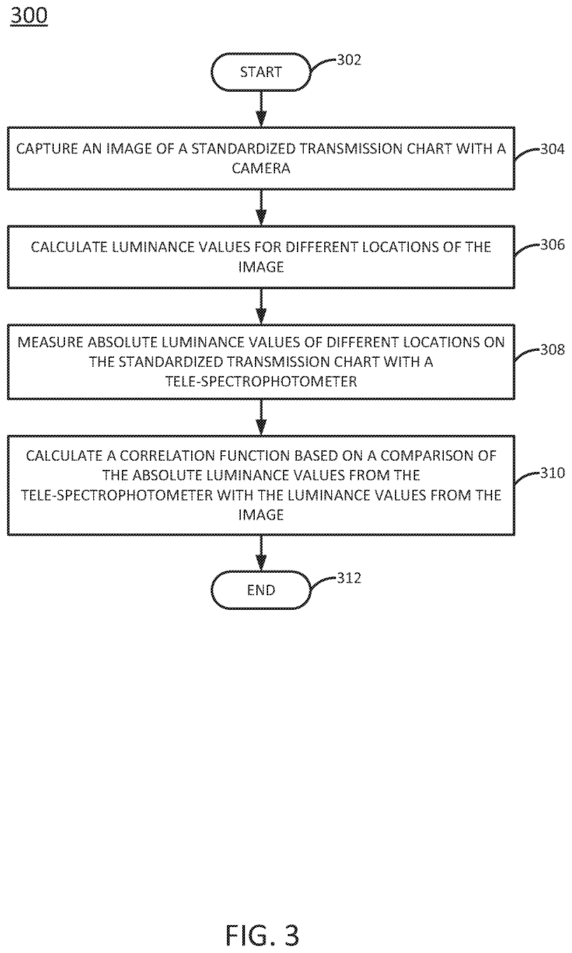

The tele-spectrophotometer 106 may be used to provide ground truth data. The measurement values obtained by the tele-spectrophotometer 106 may be used to calculate a correlation function with the luminance values obtained from the image of the standardized transmission chart 110 captured by the camera 104. Further details on how the correlation function is obtained are discussed below with reference to FIG. 3.

[owls] The correlation function may be a function that converts the luminance values obtained based on the image capturing capabilities and/or settings of the camera 104 to the actual absolute luminance values obtained by the tele-spectrophotometer 106. As a result, any camera may be used by obtaining the correlation function for a particular camera. The correlation function may then be used to obtain color data from subsequent images captured by the camera 104. The color data may then be used to generate instructions to control a 3D printer to print objects with a consistent color appearance. The instructions may also be used to determine the amount of print agents and to set print parameters of the 3D printer to print the objects with a specific color and/or opacity.

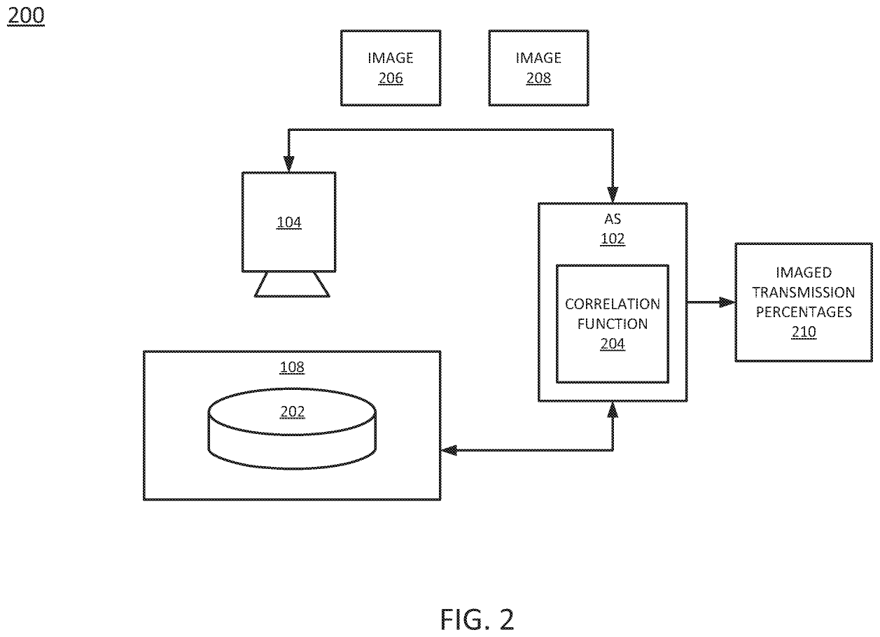

FIG. 2 illustrates an apparatus 200 for obtaining color data to control a 3D printer of the present disclosure. The apparatus 200 provides hardware that may be independent of a specific hardware configuration to obtain color data/light transmission data of an object 202 that is to be printed.

In one example, the apparatus 200 may include the AS 102, the camera 104, and the light table 108. The AS 102 may be communicatively coupled to the camera 104 and the light table 108. The AS 102 may control operations of the camera 104 and the light table 108, as described above.

The AS 102 may include a processor and a memory and perform the functions as described above in FIG. 1. In one example, the AS 102 may include a correlation function 204. As discussed above, the correlation function 204 may be applied to an image 206 captured by the camera 104 to calculate transmission percentages or values 210.

In one example, the term “transmission percentage” when used in reference to an image captured by the camera 104 may refer to an imaged transmission percentage. For example, the imaged transmission percentage may be transmission measurements that are obtained using a camera. The data may comprise light coming from the light table 108 that is directly transmitted through an object and light that is scattered within the material and captured by the camera.

In one example, a three dimensional object 202 may be placed on the light table 108. The object 202 may be analyzed by the apparatus 200 to obtain transmission percentages 210. The transmission percentages 210 may be obtained for various locations of the object 202 to ensure that the object 202 is printed with consistent color appearance. The transmission percentages 208 may ensure that each copy of the object 202 that is printed by a 3D printer has a substantially similar appearance and/or color. The amount of light that is transmitted through each portion of the object 202 may affect an appearance of each portion of the object 202. If the amount of light that passes through each portion of the object 202 is not measured or quantified objectively, each copy of the object 202 may be printed with a slightly different appearance. Such an inconsistent appearance may be undesirable for a customer.

The image 206 of the object 202 on the light table 108 may be captured by the camera 104. The image 206 may be transmitted to the AS 102 for processing. As noted above, the correlation function 204 may be applied to the image 206 to obtain an accurate luminance value for each pixel of the image 206 adjusted for the characteristics of the camera 104.

Then the object 202 may be removed from the light table 108. The camera 104 may capture an image 208 of the light emitted by the light table 108 unhindered by the object 202. The image 208 of the light table 108 without the object 202 may be transmitted to the AS 102. The correlation function 204 may be applied to the image 208 to obtain luminance values for each pixel of the image 208. Then for each pixel of the images 206 and 208 an imaged transmission percentage for the pixel may be calculated. The imaged transmission for each pixel may be provided as transmission percentages 210.

The imaged transmission percentages 210 can then be used to generate instructions used by a 3D printer to print an object 202. For example, the imaged transmission percentages 210 may be an electronic file or instructions that can be loaded into the 3D printer to determine print parameters for the object 202. For example, the imaged transmission percentages 210 may be converted into print instructions for each voxel of the object 202 during printing. For example, a particular transmission percentage at a pixel may correlate to a certain amount of print material of a particular color to obtain a desired appearance.

FIG. 3 illustrates a flow chart of an example method 300 for calculating a correlation function of the present disclosure. The method 300 may be performed by the system 100.

At block 302, the method 300 begins. At block 304, the method 300 captures an image of a standardized transmission chart with a camera. An example of the standardized transmission chart is described above and illustrated in FIG. 1. The camera may be any type of available RGB camera or monochromatic camera, as described above.

At block 306, the method 300 calculates luminance values for different locations of the image. For example, the luminance value for each different light transmission window of the standardized transmission chart may be calculated. In one example, an RGB value from the location of the image may be obtained. The RGB value may be converted into an image luminance value.

At block 308, the method 300 measures absolute luminance values of different locations on the standardized transmission chart with a tele-spectrophotometer. The tele-spectrophotometer may measure absolute luminance values in units of candelas per square meter (cd/m²). The absolute luminance values measured by the tele-spectrophotometer may provide an accurate baseline or ground truth data.

At block 310, the method 300 calculates a correlation function based on a comparison of the absolute luminance values form the tele-spectrophotometer with the luminance values from the image. For example, the luminance values from the image and the luminance values measured by the tele-spectrophotometer may be fitted to a curve or a polynomial function that may be obtained using any type of regression technique or polynomial fitting technique.

The function that is obtained may be the correlation function. The correlation function may be valid for a particular type of camera and any subsequent images captured by the camera. The correlation function may be valid also for a particular settings of the light table, the camera, and camera parameters used to capture the image (e.g., a focal distance, an exposure setting, and the like). At block 312, the method 300 ends.

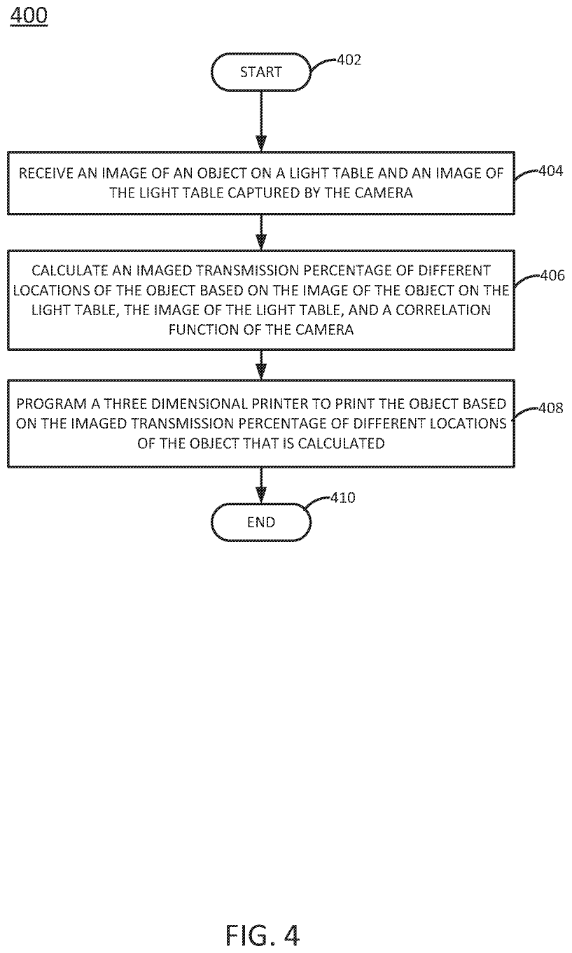

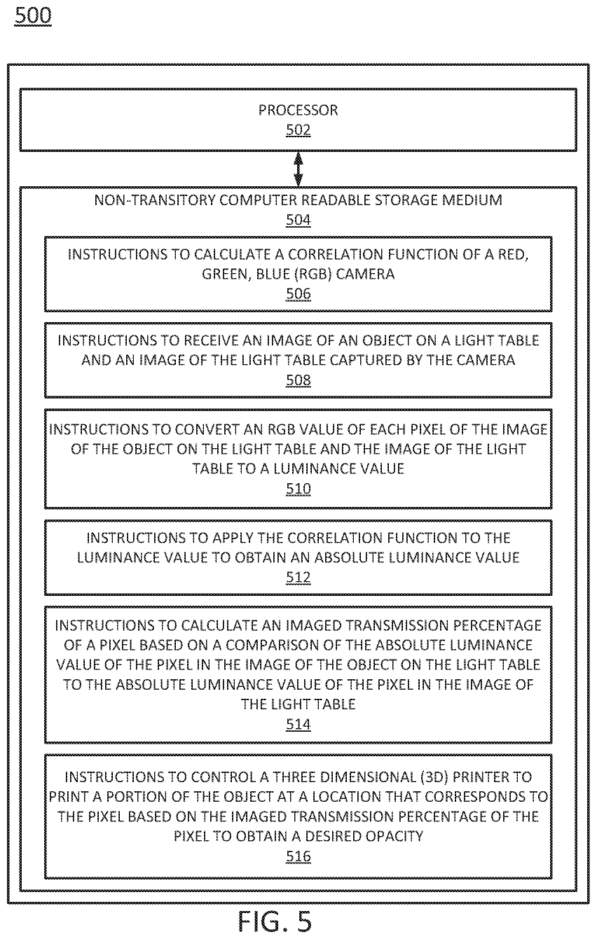

FIG. 4 illustrates a flow diagram of an example method 400 for controlling a 3D printer to print an object using light transmission data that is calculated based on the correlation function of the present disclosure. In an example, the method 400 may be performed by the apparatus 200, or the apparatus 500 illustrated in FIG. 5, and described below.

At block 402, the method 400 begins. At block 404, the method 400 receives an image of an object on a light table and an image of the light table captured by the camera. For example, the camera may capture the images in block 406 using the same parameters that were used by the camera to capture an image of the standardized transmission chart in the method 300. For example, the camera may be set to the same distance from the light table, set to the same exposure settings, set to the same viewing angle, and the like.

At block 406, the method 400 calculates an imaged transmission percentage of different locations of the object based on the image of the object on the light table, the image of the light table, and a correlation function of the camera. The correlation function of the camera may be calculated as described above and illustrated in FIG. 3.

In one example, the RGB values of each pixel of both images may be converted into respective luminance values. The correlation function may be applied to convert luminance values obtained by the camera to obtain accurate luminance values or estimated absolute luminance values in units of cd/m², for example. The estimated absolute luminance value of a particular pixel of the image of the object on the light table may be divided by the estimated absolute luminance value of a corresponding pixel of the image of the light table to obtain an imaged transmission percentage for the pixel. The calculation may be repeated for each pixel, or desired pixels associated with the object, in the image of the object on the light table and the image of the light table.

In one example, the image of the object on the light table and the image of the light table may be stored in an image format. A mask may be applied to both images to identify specific pixels of the object and stored in the form of an alpha channel (e.g., object pixels: alpha=1, background pixels: alpha=0). In another example, border pixels may be identified using image analysis and the border pixels may be excluded from calculating the imaged transmission percentage of the object.

In one example, the imaged transmission percentages may be a function of a thickness of the material or the object. Thus, the thickness of the object may be noted when comparing the imaged transmission percentages for different copies of the object.

At block 408, the method 400 programs a three dimensional printer to print the object based on the imaged transmission percentage of different locations of the object that is calculated. For example, the imaged transmission percentages may be used to determine print parameters or print settings (e.g., an amount of print agent to be dispensed at each location of the object that is printed) on a 3D printer to print the object. In one example, the imaged transmission percentages may be loaded into the 3D printer and the 3D printer may calculate the necessary print parameters for each location or voxel of the object to be printed. In another example, the imaged transmission percentages may be converted into specific print instructions (e.g., set up instructions, G-code, and the like) that can be loaded onto the 3D printer and executed by the 3D printer.

In one example, the print parameters may be an amount of printing agents or materials that is dispensed at a location during printing of the object. For example, the measured imaged transmission percentage may be used by a 3D printer to correlate the imaged transmission percentage at a location to an amount of printing agents or materials. The amount of print agents that is correlated to the imaged transmission percentage may be dispensed at the location to achieve a desired opacity. The portion of the object at the location may be printed with the correlated amount of print agents to have the desired opacity. In one example, the control may be to either achieve a uniform opacity across an object or to achieve a specific opacity difference at different locations of the object.

In one example, the imaged transmission percentage at each location of the object may be set as a reference imaged transmission percentage to obtain the desired opacity. The reference imaged transmission percentage may be used as a process control for subsequently printed copies of the object. In one example, a threshold may be defined relative to the reference image transmission percentage (e.g., 1%, 5%, 10%, and the like). Thus, when a subsequent copy of the object is printed, the imaged transmission percentage at a location of the subsequently printed object may be compared to the reference imaged transmission percentage.

If the imaged transmission percentage at the location of the subsequently printed object is within the threshold compared to the reference imaged transmission percentage at the same location, then the object may be accepted. If the imaged transmission percentage at the location of the subsequently printed object lies outside of the threshold compared to the reference imaged transmission percentage at the same location, then the object may be rejected.

In one example, the imaged transmission percentage at different locations may be compared to the reference imaged transmission percentage of the corresponding different locations. If any of the imaged transmission percentages are outside of the threshold relative to the reference imaged transmission percentage at the different locations, then the subsequently printed object may be rejected. At block 410, the method 400 ends.

FIG. 5 illustrates an example of an apparatus 500. In an example, the apparatus 500 may be the device 102. In an example, the apparatus 500 may include a processor 502 and a non-transitory computer readable storage medium 504. The non-transitory computer readable storage medium 504 may include instructions 506, 508, 510, 512, 514, and 516 that, when executed by the processor 502, cause the processor 502 to perform various functions.

In an example, the instructions 506 may include instructions to calculate a correlation function of a red, green, blue (RGB) camera. The instructions 508 may include instructions to receive an image of an object on a light table and an image of the light table captured by the camera. The instructions 510 may include instructions to convert an RGB value of each pixel of the image of the object on the light table and the image of the light table to a luminance value. The instructions 512 may include instructions to apply the correlation function to the luminance value to obtain an absolute luminance value. The instructions 514 may include instructions to calculate an imaged transmission percentage of a pixel based on a comparison of the absolute luminance value of the pixel in the image of the object on the light table to the absolute luminance value of the pixel in the image of the light table. The instructions 516 may include instructions to control a three dimensional (3D) printer to print a portion of the object at a location that corresponds to the pixel based on the image transmission percentage of the pixel to obtain a desired opacity.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a light table to hold an object;
a camera to capture images, wherein the light table is positioned within a field of view of the camera; and
a processor communicatively coupled to the camera to receive the images, wherein the processor is to analyze the images to calculate an imaged transmission percentage at a plurality of different locations of the object based on a correlation function of the camera used to determine an amount of print agents to be dispensed by a three dimensional printer to print the object.

2. The apparatus of claim 1, wherein the camera comprises a red, green, blue (RGB) camera or a monochromatic camera.

3. The apparatus of claim 1, wherein the images comprise an image of the light table, an image of the light table with the object, and an image of the light table with a standardized transmission chart.

4. The apparatus of claim 3, further comprising:
a tele-spectrophotometer to measure a luminance value of different locations on the standardized transmission chart.

5. The apparatus of claim 4, wherein the correlation function is based on a comparison of the luminance value of the different locations measured by the tele-spectrophotometer and luminance values of the different locations obtained from the image of the light table with the standardized transmission chart captured by the camera.

6. A method comprising:
receiving, by the processor, an image of an object on a light table and an image of the light table captured by the camera;
calculating, by the processor, an imaged transmission percentage of different locations of the object based on the image of the object on the light table, the image of the light table, and a correlation function of the camera; and
programming, by the processor, a three dimensional printer to print the object based on the imaged transmission percentage of different locations of the object that is calculated.

7. The method of claim 6, further comprising:
calculating the correlation function of the camera, wherein the calculating comprises:
receiving, by the processor, an image of the light table with a standardized transmission chart to calculate luminance values of different locations of the standardized transmission chart;
receiving, by the processor, luminance values of the different locations of the standardized transmission chart on the light table from a tele-spectrophotometer; and
calculating, by the processor, the correlation function based on a comparison of the luminance values from the image and the luminance values from the tele-spectrophotometer.

8. The method of claim 7, wherein the luminance values are calculated from the image by converting red, green, blue (RGB) values of each pixel of the image at the different locations.

9. The method of claim 7, wherein the calculating the correlation function comprises performing a polynomial fit between the luminance values from the image and the luminance values from the tele-spectrophotometer.

10. The method of claim 6, wherein the calculating the imaged transmission percentage, comprises:
converting, by the processor, each pixel at the different locations of the image of the object on the light table and the image of the light table from red, green, blue (RGB) values into luminance values;
calculating, by the processor, absolute luminance values by applying the correlation function to the luminance values; and
dividing, by the processor, for each pixel a respective absolute luminance value from the image of the object on the light table by a respective absolute luminance value from the image of the light table.

11. The method of claim 6, wherein the programming the 3D printer, comprises:
correlating, by the processor, the imaged transmission percentage at a location of the different locations to an amount of printing agents;
dispensing, by the processor, the amount of print agents at the location to achieve a desired opacity; and
printing, by the processor, a portion of the object at the location to have the desired opacity.

12. A non-transitory computer readable storage medium encoded with instructions executable by a processor, the non-transitory computer-readable storage medium comprising:
instructions to calculate a correlation function of a red, green, blue (RGB) camera;
instructions to receive an image of an object on a light table and an image of the light table captured by the camera;
instructions to convert an RGB value of each pixel of the image of the object on the light table and the image of the light table to a luminance value;
instructions to apply the correlation function to the luminance value to obtain an absolute luminance value;
instructions to calculate an imaged transmission percentage of a pixel based on a comparison of the absolute luminance value of the pixel in the image of the object on the light table to the absolute luminance value of the pixel in the image of the light table; and
instructions to control a three dimensional (3D) printer to print a portion of the object at a location that corresponds to the pixel based on the imaged transmission percentage of the pixel to obtain a desired opacity.

13. The non-transitory computer readable storage medium of claim 12, further comprising:
instructions to set the transmission percentage associated with the desired opacity to a reference transmission percentage, wherein a subsequently printed object is accepted when a transmission percentage of the subsequently printed object is within a threshold of the reference transmission percentage at a corresponding location.

14. The non-transitory computer readable storage medium of claim 12, wherein the instructions to calculate the correlation function of the RGB camera, comprises:
instructions to receive an image of the light table with a standardized transmission chart to calculate luminance values of different locations of the standardized transmission chart;
instructions to receive luminance values of the different locations of the standardized transmission chart on the light table from a tele-spectrophotometer; and
instructions to calculate the correlation function based on a comparison of the luminance values from the image and the luminance values from the tele-spectrophotometer.

15. The non-transitory computer readable storage medium of claim 14, wherein the luminance values are calculated from the image by converting red, green, blue (RGB) values of each pixel of the image at the different locations.
